(19) United States
(12) Patent Application Publication
(10) Pub. No.: US 2022/0147573 A1
(43) Pub. Date: May 12, 2022

(54) SEARCH CONDITION PRESENTATION APPARATUS, SEARCH CONDITION PRESENTATION METHOD, AND RECORDING MEDIUM

(71) Applicant: Hitachi, Ltd., Tokyo (JP)

(72) Inventors: Yoichi KAWACHIYA, Tokyo (JP); Keiro MURO, Tokyo (JP); Hiroaki SHIKANO, Tokyo (JP); Satoru WATANABE, Tokyo (JP)

(21) Appl. No.: 17/482,161

(22) Filed: Sep. 22, 2021

(30) Foreign Application Priority Data
Nov. 11, 2020 (JP) 2020-187872

(51) Int. Cl. G06F 16/9038; G06F 16/901

(52) U.S. Cl. CPC G06F 16/9038; G06F 16/901

(57) ABSTRACT

An apparatus that presents a search condition, which is an execution condition to be searched, for a correlation model that calculates an index related to an execution result of process according to the execution condition from predetermined execution conditions, includes: an importance calculation unit configured to calculate the importance of searching for each of a plurality of divided regions belonging to the search space, which is a space that the execution condition can take; an execution cost calculation unit configured to calculate an execution cost required for the process under the execution condition corresponding to the divided region; and a divided region selection unit and a screen output unit configured to select a divided region to be actually searched from the plurality of divided regions on the basis of the importance and the execution cost, and present an execution condition corresponding to the selected divided region as a search condition.

### CROSS-REFERENCE TO RELATED APPLICATIONS

This application claims priority from Japanese Patent Application No. 2020-187872 filed Nov. 11, 2020. The entire content of the priority application is incorporated herein by reference.

### BACKGROUND

The present disclosure relates to a technique for presenting a search condition, which is an execution condition to be searched, for a correlation model that calculates an index related to an execution result of processing according to the execution condition, from predetermined execution conditions.

In recent years, IoT (Internet of Things) data has been utilized to analyze production processes in facilities of plants and the like. For example, as an analysis of the production process, a correlation model is created in which the feature amount at the time of production in the facility is input and a target index such as the quality of the product to be produced is output, and how the target index will be is analyzed while changing the feature amount at the time of production using the correlation model.

Such a model is created, for example, by acquiring a large number of correspondences between the feature amount and the target index. However, it takes time, effort, and cost to acquire a large number of correspondences. In addition, if there is aging deterioration of facility or facility changes, it is necessary to acquire a large number of new correspondences between feature amounts and target indices in order to optimize the model, which takes a lot of time and cost.

In contrast, Japanese Patent Application Publication No. 2019-159933 discloses a technique of generating a region in a parameter space of each search candidate point using the positions of search points in the past search result close to a search candidate point, an estimated search time corresponding to each search candidate point, and an upper-limit confidence section corresponding to each search candidate point in order to shorten the time related to optimization of parameters and determining a search point on the basis of the size of the region in the parameter space.

### SUMMARY

Japanese Patent Application Publication No. 2019-159933 relates to a technique for shortening the time related to the optimization of parameters, and for example, the cost other than the time is not taken into consideration.

The present disclosure has been made in view of the problems, and an object thereof is to provide a technique capable of easily and appropriately presenting search conditions, which are execution conditions to be searched, for a correlation model.

In order to attain the object, a search condition presentation apparatus according to an aspect is a search condition presentation apparatus that presents a search condition, which is an execution condition to be searched, for a correlation model that calculates an index related to an execution result of processing according to the execution condition, from predetermined execution conditions, including: an importance calculation unit configured to calculate a importance of searching for each of a plurality of divided regions belonging to a search space, which is a space that the execution condition can take; an execution cost calculation unit configured to calculate an execution cost required for the processing under a execution condition corresponding to the divided region; and a selection presentation unit configured to select a divided region to be actually searched from the plurality of divided regions on the basis of the importance and the execution cost and present an execution condition corresponding to the selected divided region as a search condition.

### BRIEF DESCRIPTION OF THE DRAWINGS

FIG. 1 is a diagram illustrating an outline of an embodiment.

FIG. 2 is a diagram illustrating an overall configuration of a search condition presentation system according to an embodiment.

FIG. 3 is a diagram illustrating a configuration of a facility according to an embodiment.

FIG. 4 is a diagram illustrating a configuration of a search condition presentation apparatus according to an embodiment.

FIG. 5 is a diagram illustrating a configuration of model generation input data according to an embodiment.

FIG. 6 is a diagram illustrating a configuration of facility configuration data according to an embodiment.

FIG. 7 is a block diagram of experimental cost data according to an embodiment.

FIG. 8 is a block diagram of production plan data according to an embodiment.

FIG. 9 is a flowchart of a search condition presentation process according to an embodiment.

FIG. 10 is a flowchart of a model reference process according to an embodiment.

FIG. 11 is a flowchart of a search space division process according to an embodiment.

FIG. 12 is a flowchart of an importance calculation process according to an embodiment.

FIG. 13 is a flowchart of an experimental time and expense calculation process according to an embodiment.

FIG. 14 is a flowchart of an experimental mutual time and mutual expense calculation process according to an embodiment.

FIG. 15 is a flowchart of a divided region selection process according to an embodiment.

FIG. 16 is a flowchart of a screen output process according to an embodiment.

FIG. 17 is a diagram illustrating an example of a search support screen according to an embodiment.

FIG. 18 is a block diagram of experimental mutual cost data according to an embodiment.

### DETAILED DESCRIPTION OF THE EMBODIMENT

Embodiments will be described with reference to the drawings. The embodiments described below are not intended to limit the inventions according to the claims, and all elements and combinations thereof described in the embodiments are not necessarily essential to the solving means for the invention.

First, an outline of an embodiment will be described.

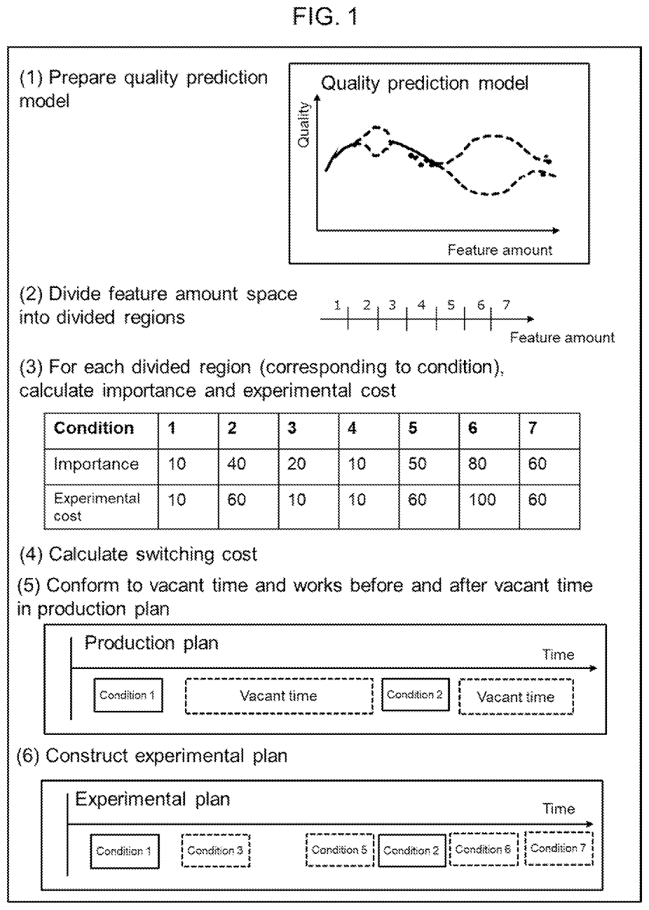

FIG. 1 is a diagram illustrating an outline of an embodiment.

First, a model (quality prediction model) illustrating the relative relationship between one or more types of feature amounts (one type of feature amounts in the example of FIG. 1) at the time of production and quality of a predetermined product in a facility is prepared (FIG. 1(1)). Here, the feature amount is a condition at the time of production. The quality prediction model is a model that receives a feature amount as an input and outputs a value (quality value) indicating quality. When creating a quality prediction model, it is difficult to actually acquire the quality for all feature amounts. Therefore, for example, the quality prediction model is created from the relationship between the feature amounts in a limited range and the quality values corresponding to the feature amounts. The broken line portion in the quality prediction model of FIG. 1(1) is an uncertain portion in the quality prediction model.

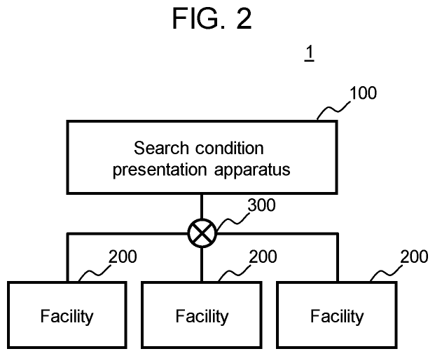

Subsequently, a search condition presentation apparatus 100 (see FIG. 2) divides the space (feature amount space) that the feature amount can take into a plurality of divided regions (FIG. 1(2)). In the example of FIG. 1, there is one type of feature amount, and the feature amount space is divided into, for example, seven divided regions. Here, each of the divided regions corresponds to a feature amount, which means a condition in production. The feature amount (condition) corresponding to the divided region may be the center value, the maximum value, or the minimum value in the divided region.

Subsequently, the search condition presentation apparatus 100 calculates the importance of the search for evaluating or improving the accuracy of the quality prediction model, and the cost (experimental cost) of an experiment of the condition corresponding to the divided region for each divided region, that is, for each condition corresponding to the divided region (FIG. 1(3)).

Subsequently, the search condition presentation apparatus 100 calculates the cost (switching cost) required for switching from an experiment corresponding to each divided region to an experiment (process) corresponding to another divided region (FIG. 1(4)).

Subsequently, the search condition presentation apparatus 100 identifies the vacant time from the production plan (operation plan) in the facility and identifies a set (divided region set) of one or more divided regions conforming to the vacant time and the work (processing) before and after the vacant time on the basis of the experimental cost, the switching cost, and the like (FIG. 1(5)). Here, the work indicates the work in the production plan and the work of the experiment corresponding to another divided region. In addition, conforming also includes, for example, that the order of works is made such that the experimental cost is reduced as a whole.

Subsequently, the search condition presentation apparatus 100 constructs and presents an experimental plan in which the divided region set identified in FIG. 1(5) is incorporated into the production plan (FIG. 1(6)). If there is a plurality of conforming divided region sets, each experimental plan may be selected on the basis of the importance of the divided region sets included in the experimental plan, or displayed in the order based on the importance.

Next, a search condition presentation system according to an embodiment will be described in detail.

FIG. 2 is a diagram illustrating an overall configuration of a search condition presentation system according to an embodiment.

A search condition presentation system 1 includes the search condition presentation apparatus 100, one or more facilities 200, and a communication path 300 coupling these apparatuses.

The communication path 300 is, for example, a communication path such as a wired LAN (Local Area Network) or a wireless LAN.

The facility 200 is a facility for producing a predetermined product, and the execution conditions (feature amounts) for producing the product can be changed.

The search condition presentation apparatus 100 executes processing for presenting a feature amount (search condition) to be searched in order to evaluate a correlation model or improve the accuracy of the correlation model (also referred to simply as a model) that calculates an index (for example, a value indicating the quality of a product) related to the execution result of processing according to a feature amount from the feature amounts of the facility 200.

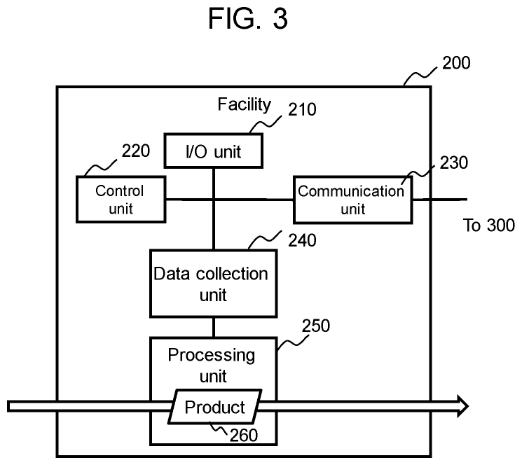

FIG. 3 is a diagram illustrating a configuration of a facility according to an embodiment.

The facility 200 includes an input/output unit 210, a control unit 220, a communication unit 230, a data collection unit 240, and a processing unit 250.

The processing unit 250 produces a product 260 according to designated conditions. The processing unit 250 is, for example, a unit for kneading rubber from raw materials. In this example, various conditions such as the temperature at which the rubber is kneaded, the rotation speed of a screw for kneading the rubber, the electric power applied to the screw, and the like can be designated for the processing unit 250. The processing unit 250 is provided with various sensors for detecting various states during production of the product 260.

The data collection unit 240 collects data such as sensor values obtained by each sensor at the time of production of the product 260 in the processing unit 250. The communication unit 230 is an interface such as a wired LAN card or a wireless LAN card, and communicates with another apparatus (for example, the search condition presentation apparatus 100) via the communication path 300.

The input/output unit 210 executes processing of receiving various pieces of information from the user of the facility 200 via an interface device such as a keyboard, and executes processing of outputting the information to the user via an interface device such as a monitor.

The control unit 220 controls each unit of the facility 200 in an integrated manner. For example, the control unit 220 transmits various pieces of measurement data during production in the processing unit 250 collected by the data collection unit 240 and data such as the quality of the product produced at that time (for example, model generation input data 131 described later) to the search condition presentation apparatus 100 via the communication unit 230.

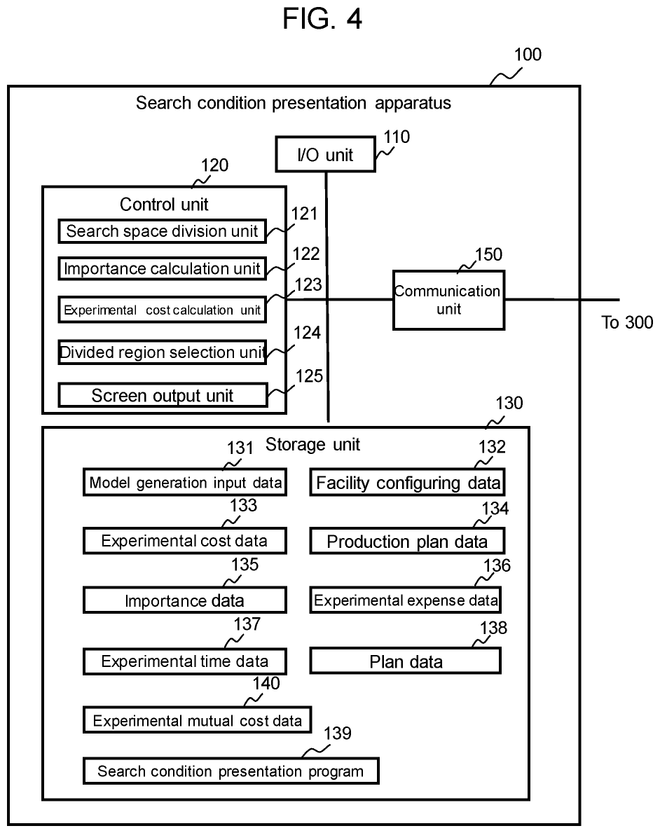

FIG. 4 is a diagram illustrating a configuration of a search condition presentation apparatus according to an embodiment.

The search condition presentation apparatus 100 is configured by, for example, a PC (Personal Computer). The search condition presentation apparatus 100 includes an input/output unit 110, a control unit 120, a storage unit 130, and a communication unit 150.

The communication unit 150 is, for example, an interface such as a wired LAN card or a wireless LAN card, and communicates with other apparatuses (for example, the facility 200) via the communication path 300.

The control unit 120 is, for example, a processor such as a CPU (Central Processing Unit), and executes various processes according to a program stored in the storage unit 130. In the present embodiment, the control unit 120 executes a search condition presentation program 139, which will be described later, to constitute the functional units including a search space division unit 121, an importance calculation unit 122, an experimental cost calculation unit 123, and a divided region selection unit 124, and a screen output unit 125. Here, the divided region selection unit 124 and the screen output unit 125 correspond to a selection presentation unit, and the experimental cost calculation unit 123 corresponds to an execution cost calculation unit. The detailed processing of each functional unit will be described later.

The input/output unit 110 executes processing of receiving various pieces of information from the user of the search condition presentation apparatus 100 via an interface device such as a keyboard, and also executes processing of outputting the information to the user via an interface device such as a monitor.

The storage unit 130 stores a program to be executed by the control unit 120 and various pieces of information used in this program. The storage unit 130 may be, for example, a semiconductor memory, a flash memory, an HDD (Hard Disk Drive), an SSD (Solid State Drive), or the like, and may be a volatile memory or a nonvolatile memory.

The storage unit 130 stores model generation input data 131, facility configuration data 132, experimental cost data 133, production plan data 134, importance data 135, experimental expense data 136, experimental time data 137, and plan data 138, experimental mutual cost data 140, and a search condition presentation program 139.

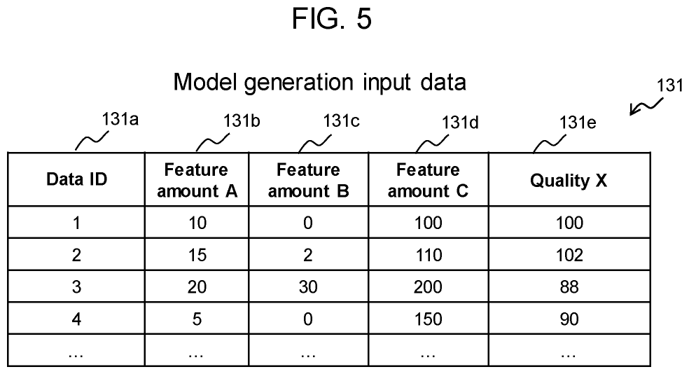

For example, the model generation input data 131, the facility configuration data 132, the experimental cost data 133, and the production plan data 134 may be stored in a database configured by a drive such as an HDD or SSD. These pieces of data will be described later with reference to FIGS. 5 to 8.

On the other hand, the importance data 135, the experimental expense data 136, the experimental time data 137, the plan data 138, and the experimental mutual cost data 140 maybe stored in, for example, a memory. The importance data 135 is the data of importance corresponding to each divided region. The experimental expense data 136 is data of the experimental expense corresponding to each divided region and the experimental mutual expense corresponding to a plurality of divided region sets. The experimental time data 137 is the data of the experimental time corresponding to each divided region. The plan data 138 is information in which the process of the divided region set to be executed is incorporated into the production process, and this information is correlated with the importance of the corresponding divided region set.

The search condition presentation program 139 is a program that executes a search condition presentation process described later.

Next, the detailed configuration of the model generation input data 131 will be described.

FIG. 5 is a diagram illustrating a configuration of model generation input data according to an embodiment.

The model generation input data 131 is data input (used) for generating a model, and includes entries corresponding to each production process. The entry of the model generation input data 131 includes the fields of data ID 131a, feature amount A 131b, feature amount B 131c, feature amount C 131d, and quality X 131e.

The data ID 131a stores an ID (data ID) for identifying the data corresponding to the entry. The feature amount A 131b stores the value of the feature amount A in the process corresponding to the entry. The feature amount B 131c stores the value of the feature amount B in the process corresponding to the entry. The feature amount C 131d stores the value of the feature amount C in the process corresponding to the entry. The quality X 131e stores a value (quality value) indicating the quality of the product produced in the process corresponding to the entry.

Next, the detailed configuration of the facility configuration data 132 will be described.

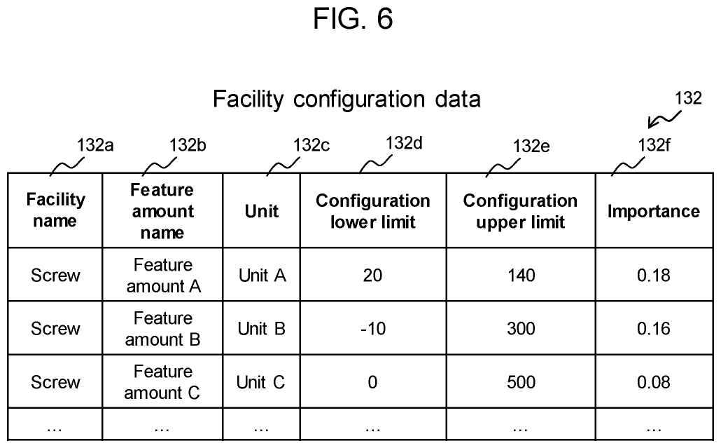

FIG. 6 is a diagram illustrating a configuration of facility configuration data according to an embodiment.

The facility configuration data 132 is data related to the configuration in the facility 200, and includes, for example, entries for each feature amount. The entry of the facility configuration data 132 includes the fields of facility name 132a, feature amount name 132b, unit 132c, configuration lower limit 132d, configuration upper limit 132e, and importance 132f.

The facility name 132a stores the name (facility name) of a facility related to the feature amount corresponding to the entry. The feature amount name 132b stores the name (feature amount name) of a feature amount corresponding to the entry. The unit 132c stores the unit for the feature amount corresponding to the entry. In the configuration lower limit 132d, a lower limit value that can be configure for the feature amount corresponding to the entry is stored. In the configuration upper limit 132e, an upper limit value that can be configure for the feature amount corresponding to the entry is stored. Therefore, the feature amount corresponding to the entry can set the range of the lower limit value of the configuration lower limit 132d and the upper limit value of the configuration upper limit 132e, and for this feature amount, this range is the search range (search space). In the importance 132f , the importance (influence) on the quality of the feature amount corresponding to the entry is stored. The greater the importance, the greater the influence on the quality of the product.

Next, the detailed configuration of the experimental cost data 133 will be described.

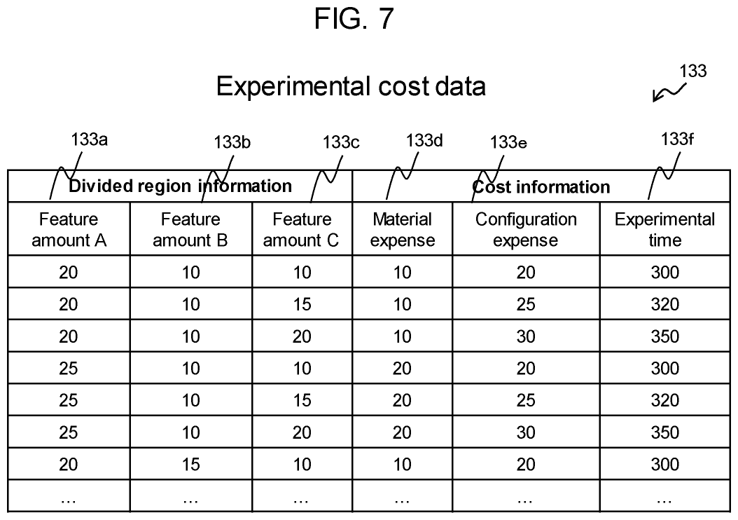

FIG. 7 is a block diagram of experimental cost data according to an embodiment.

The experimental cost data 133 is data related to the cost required for producing a product as an experiment using the facility 200 for the divided region, and stores, for example, entries for each divided region. The entry of the experimental cost data 133 includes the divided region information including the fields of the feature amount A 133a, the feature amount B 133b, and the feature amount C 133c, and the cost information including the fields of the material expense 133d, the configuration expense 133e, and the experimental time 133f.

The feature amount A 133a stores the value of the feature amount A in the divided region corresponding to the entry. The feature amount B 133b stores the value of the feature amount B in the divided region corresponding to the entry. The feature amount C 133c stores the value of the feature amount C in the divided region corresponding to the entry. The material expense 133d stores the expense of the material used for the experiment under the condition of the divided region corresponding to the entry. The configuration expense 133e stores the expense required for configuration in the experiment under the condition of the divided region corresponding to the entry. In the experimental time 133f, the time (experimental time) required for the experiment corresponding to the divided region corresponding to the entry is stored.

Next, the detailed configuration of the production plan data 134 will be described.

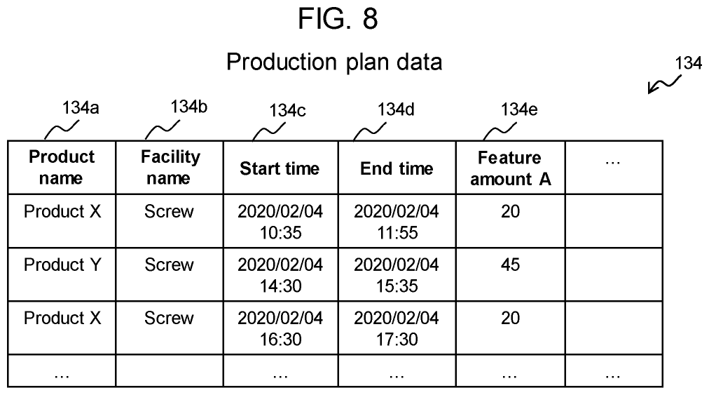

FIG. 8 is a block diagram of production plan data according to an embodiment.

The production plan data 134 is data related to a work plan for producing an actual product, and stores entries for each work for producing the product. The entry of the production plan data 134 includes the fields of product name 134a, facility name 134b, start time point 134c, end time 134d, feature amount A 134e, and the like. Although not illustrated, the entries of the feature amount B and the feature amount C are also included.

In the product name 134a, the name of the product produced by the work corresponding to the entry is stored. The facility name 134b stores the facility name used in the work corresponding to the entry. The start time point 134c stores the date and time (start date and time) at which the work corresponding to the entry starts. The end time 134d stores the date and time (end date and time) at which the work corresponding to the entry ends. The feature amount A 134e stores the value of the feature amount A in the work corresponding to the entry. According to the production plan data 134, since the date and time when each work is executed can be specified, the vacant time when the facility can be used can be specified.

Next, the detailed configuration of the experimental mutual cost data 140 will be described.

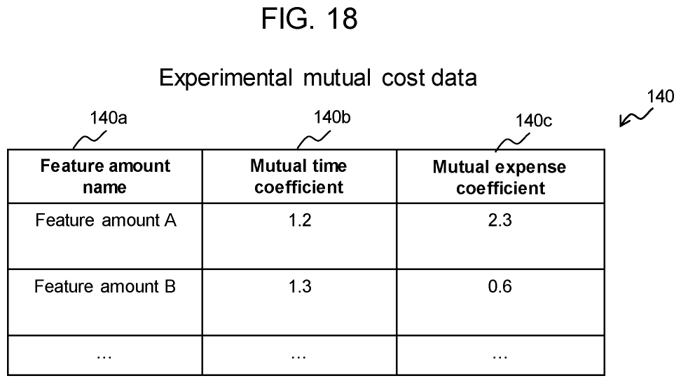

FIG. 18 is a block diagram of experimental mutual cost data according to an embodiment.

The experimental mutual cost data 140 is data related to the cost (time, expense) when switching for each feature amount, and includes entries corresponding to each feature amount. The entry of the experimental mutual cost data 140 includes the fields of feature amount name 140a, mutual time coefficient 140b, and mutual expense coefficient 140c.

The feature amount name 140a stores the name (feature amount name) of a feature amount corresponding to the entry. The mutual time coefficient 140b stores a coefficient (mutual time coefficient) related to the time when switching in the feature amount corresponding to the entry. The mutual time coefficient is, for example, the time required for switching a unit feature amount. The mutual expense coefficient 140c stores a coefficient (mutual expense coefficient) related to the expense at the time of switching in the feature amount corresponding to the entry. The mutual expense coefficient is, for example, the expense required for switching a unit feature amount.

Next, the processing operation by the search condition presentation apparatus 100 will be described.

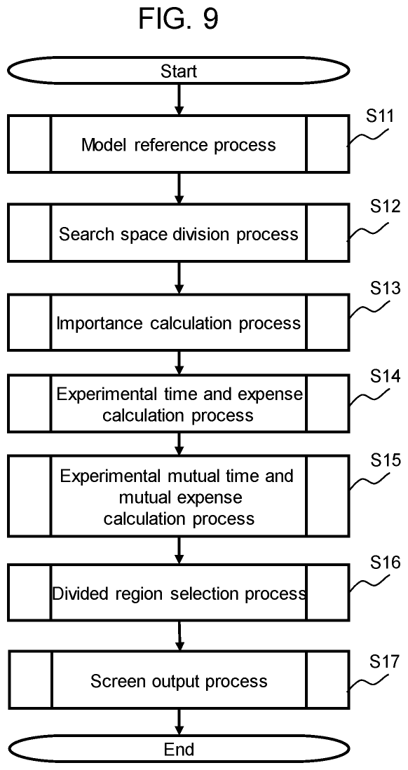

FIG. 9 is a flowchart of a search condition presentation process according to an embodiment.

The search condition presentation process is started, for example, when the search condition presentation apparatus 100 receives the designated input of the model generation input data 131 used for creating a processing target correlation model (in the description of this process, referred to as a target model) and the designated input of the production plan data 134 in the target facility 200 from the user via the input/output unit 110 and receives a processing execution instruction from the user.

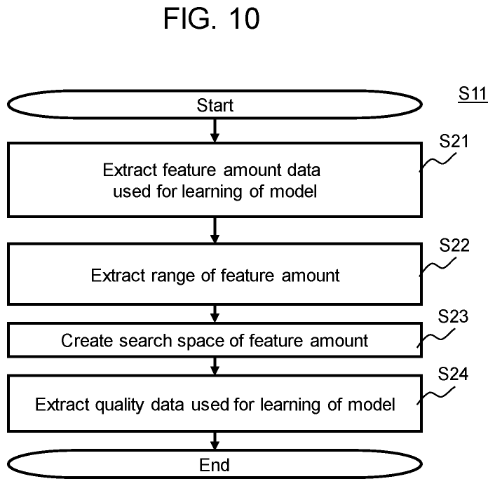

First, the search space division unit 121 of the search condition presentation apparatus 100 executes a model reference process (see FIG. 10) of extracting necessary data from the model generation input data 131 used for learning the target model and creating a search space (step S11).

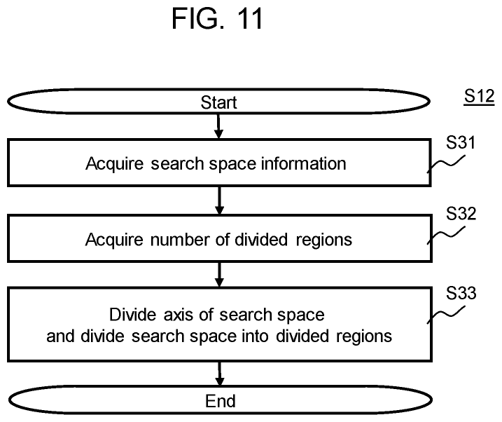

Subsequently, the search space division unit 121 executes a search space division process (see FIG. 11) of dividing the search space into a plurality of divided regions (step S12).

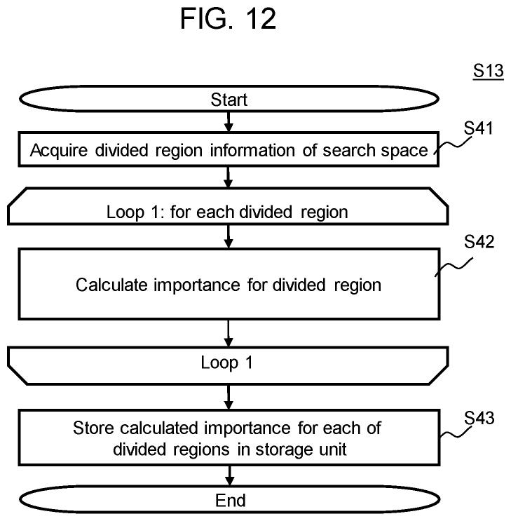

Subsequently, the importance calculation unit 122 of the search condition presentation apparatus 100 executes an importance calculation process (see FIG. 12) of calculating the importance of performing search in order to evaluate the target model for each divided region (step S13).

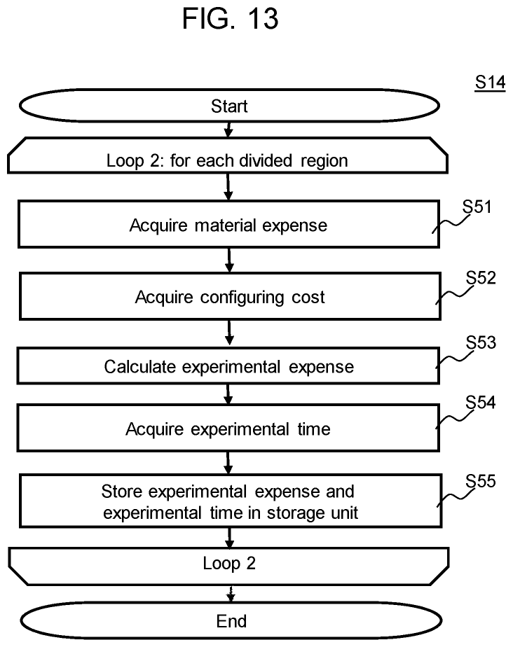

Subsequently, the experimental cost calculation unit 123 of the search condition presentation apparatus 100 executes an experimental time and expense calculation process (see FIG. 13) of calculating a time (experimental time) and expense required for an experiment in the facility 200 under the execution condition corresponding to each divided region (step S14).

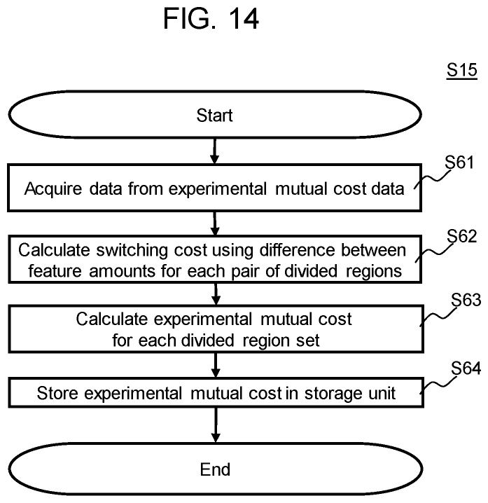

Subsequently, the experimental cost calculation unit 123 of the search condition presentation apparatus 100 executes an experimental mutual time and mutual expense calculation process (see FIG. 14) of calculating a time (experimental mutual time) and expense (mutual expense) required for switching an experiment when performing an experiment under execution conditions corresponding to a plurality of divided regions (step S15).

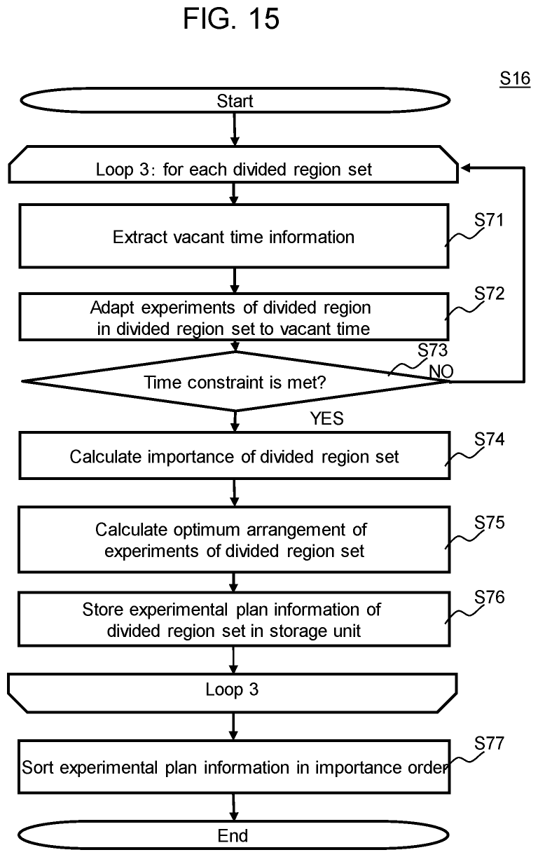

Subsequently, the divided region selection unit 124 of the search condition presentation apparatus 100 executes a divided region selection process (see FIG. 15) of selecting a set of one or more divided regions conforming to the vacant time of the production plan and generating an experimental plan (step S16).

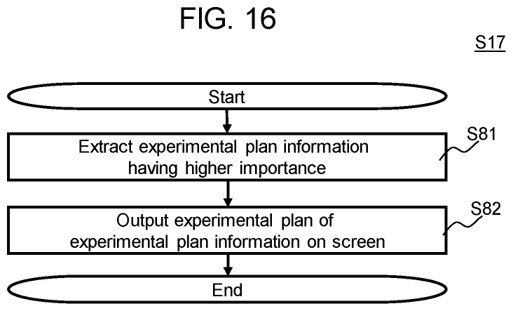

Subsequently, the screen output unit 125 of the search condition presentation apparatus 100 executes a screen output process (see FIG. 16) of extracting and presenting an experimental plan from the generated experimental plans (step S17).

Next, the model reference process in step S11 of FIG. 9 will be described.

FIG. 10 is a flowchart of the model reference process according to an embodiment.

In the model reference process, the search space division unit 121 extracts feature amount data from the model generation input data 131 used for learning the designated target model (step S21). For example, the search space division unit 121 acquires the feature amount A, the feature amount B, and the feature amount C stored in the feature amount A 131b, the feature amount B 131c, and the feature amount C 131d of the designated model generation input data 131.

Subsequently, the search space division unit 121 extracts information on the range of each feature amount from the facility configuration data 132 (step S22). Specifically, the search space division unit 121 acquires the configuration lower limit value of the configuration lower limit 132d and the configuration upper limit value of the configuration upper limit 132e of the entry corresponding to the feature amount of the facility configuration data 132 for each feature amount and configures the range of the configuration lower limit value and the configuration upper limit value as the range of the feature amount.

Subsequently, the search space division unit 121 creates a search space defined by the range of each feature amount extracted in step S22 (step S23). Specifically, the search space division unit 121 creates a search space in which each feature amount is set as one axis and the range in each axis is set as the range of the feature amount extracted in step S22. Here, the search space is the range on one line when there is one type of feature amount, the search space is a plane defined by of two axes when there are two types of feature amount, and the search space is a solid defined by three axes when there are three types of feature amount.

Subsequently, the search space division unit 121 extracts quality data from the model generation input data 131 used for learning the designated target model (step S24). For example, the search space division unit 121 acquires the quality value of the quality X 131e of the designated model generation input data 131.

According to the model reference process, it is possible to create a search space for the feature amount that is the input of the target model.

Next, the search space division process in step S12 of FIG. 9 will be described.

FIG. 11 is a flowchart of a search space division process according to an embodiment.

In the search space division process, the search space division unit 121 acquires information on the search space created by the model reference process, that is, one or more axes corresponding to the feature amounts of the search space and the range of values of each axis (step S31).

Subsequently, the search space division unit 121 acquires the number of divided regions (divided region number) created by dividing the search space (step S32). The divided region number maybe acquired from the user via the input/output unit 110, or may be a default value.

Subsequently, the search space division unit 121 divides the search space into divided regions by dividing the range of values of each axis of the search space on the basis of the acquired divided region number (step S33). Specifically, the range of values of each axis constituting the search space is divided so that the number multiplied by the number of divided ranges of each axis is equal to or close to the acquired divided region number. For example, when the search space is defined of one axis of feature amount, the range of the values of the axis is divided so that the number of divided regions obtained by division is the acquired divided region number. Here, the number of divisions in each of a plurality of axes constituting the search space may be a number proportional to the degree of influence of the feature amount represented by the axis on the target model (the importance of the importance 132f of the facility setting data 132). That is, the axis of the feature amount having a high degree of influence maybe divided into a larger number of divisions, that is, a larger number of ranges. In this way, the feature amount having a high degree of influence can be divided into many divided regions, and the feature amount can be experimented in detail.

Next, the importance calculation process in step S13 of FIG. 9 will be described.

FIG. 12 is a flowchart of the importance calculation process according to an embodiment.

In the importance calculation process, the importance calculation unit 122 acquires information on the divided regions of the search space divided by the search space division process (specifically, information on the feature amount corresponding to the divided regions) (step S41).

Subsequently, the importance calculation unit 122 executes the processing of loop 1 (step S42) for each divided region.

That is, the importance calculation unit 122 calculates the importance related to the evaluation and the like of the target model for the target divided region (step S42). As a method of calculating the importance, for example, Probability of Improvement in the acquisition function of Bayesian optimization may be used.

When the processing of loop 1 is executed for each divided region and the processing of loop 1 is completed for all the divided regions, the importance calculation unit 122 stores importance data 135 in which the calculated importance for each divided region is correlated with the divided region in the storage unit 130 (step S43).

According to the importance calculation process, the importance for each divided region can be appropriately calculated.

Next, the experimental time and expense calculation process in step S14 of FIG. 9 will be described.

FIG. 13 is a flowchart of the experimental time and expense calculation process according to an embodiment.

In the experimental time and expense calculation process, the experimental cost calculation unit 123 executes the processing of loop 2 (steps S51 to S56) for each divided region. Here, in the description of this process, the divided region which is a target for the process is referred to as a target divided region.

That is, the experimental cost calculation unit 123 acquires the material expense in the experiment under the execution condition corresponding to the target divided region from the experimental cost data 133 (step S51). Subsequently, the experimental cost calculation unit 123 acquires the configuration cost in the experiment under the execution condition corresponding to the target divided region from the experimental cost data 133 (step S52). Subsequently, the experimental cost calculation unit 123 calculates the expense (experimental expense) in the experiment under the execution condition corresponding to the target divided region on the basis of the acquired material expense and configuration cost (step S53).

Subsequently, the experimental cost calculation unit 123 acquires the time (experimental time) in the experiment under the execution condition corresponding to the target divided region from the experimental cost data 133 (step S54).

Subsequently, the experimental cost calculation unit 123 stores the experimental expense data 136 and the experimental time data 137 in which the calculated experimental expense and experimental time are correlated with the divided region, respectively, in the storage unit 130 (step S55).

Subsequently, when the processing of loop 2 is executed for each divided region, and the processing of loop 2 is completed for all divided regions, the experimental cost calculation unit 123 ends the experimental time and expense calculation process.

Next, the experimental mutual time and mutual expense calculation process in step S15 of FIG. 9 will be described.

FIG. 14 is a flowchart of the experimental mutual time and mutual expense calculation process according to an embodiment.

In the experimental mutual time and mutual expense calculation process, the experimental cost calculation unit 123 acquires data related to the cost when switching for each feature amount from the experiment mutual cost data, for example, the mutual time coefficient and the mutual expense coefficient (step S61).

Subsequently, the experimental cost calculation unit 123 calculates the cost (switching cost: switching time, switching expense) for switching from the experiment of one divided region to the experiment of the other divided region on the basis of the difference in the feature amount for each of two divided regions (divided region pair) in the search space (step S62).

For example, the experimental cost calculation unit 123 calculates the switching cost Cost on the basis of the following equation (1).

Cost=Σₖ₌₁ⁿ aₖ|Val_afterₖ−Val_beforeₖ| (1)

Here, n indicates the number of types of feature amount, and aₖ is a weighting coefficient related to the cost of the feature amount. Specifically, when calculating the switching time, it is a mutual time coefficient. When calculating the switching expense, it is a mutual cost coefficient. Moreover, Val_afterₖ is the value of the feature amount in the divided region after switching, and Val_beforeₖ is the value of the feature amount in the divided region before switching.

For example, when the divided region pair switches from a divided region (condition 1) in which the feature amount A is 20 and the feature amount B is 30 to a divided region (condition 2) in which the feature amount A is 10 and the feature amount B is 45, the value obtained by adding the value obtained by multiplying the difference 10 of the feature amount A by the cost of the unit feature amount of the feature amount A and the value obtained by multiplying the difference 15 of the feature amount B by the cost of the unit feature amount of the feature amount B is the switching cost.

Subsequently, the experimental cost calculation unit 123 calculates an experimental mutual cost (experimental mutual time, experimental mutual expense), which is the total of the switching costs for switching to the respective divided regions in a divided region set for each of the sets of divided regions (divided region sets), which is a permutation of all the sets composed of one or more divided regions in the search space (step S63).

Subsequently, the experimental cost calculation unit 123 stores the data in which the experiment mutual cost is correlated with the divided region set in the storage unit 130 (step S64).

Next, the divided region selection process in step S16 of FIG. 9 will be described.

FIG. 15 is a flowchart of the divided region selection process according to an embodiment.

In the divided region selection process, the divided region selection unit 124 executes the processing of loop 3 (steps S71 to S76) for each divided region set. Here, in the description of this process, the divided region set which is a target of process is referred to as a target divided region set.

That is, the divided region selection unit 124 extracts information on the vacant time of the facility from the production plan data 134 (step S71). Subsequently, the divided region selection unit 124 performs a process of adapting the experiment corresponding to each divided region of the target divided region set to the extracted vacant time (step S72). Subsequently, the divided region selection unit 124 determines whether the time constraint is met, that is, whether all the divided regions of the target divided region set can be adapted to the vacant time (step S73). The mutual experimental time may be taken into consideration in determining whether the time constraint is met.

When the time constraint is not met (step S73: NO), the divided region selection unit 124 ends the processing of loop 3 for the target divided region set, and performs the processing of loop 3 using the next divided region set as the processing target.

On the other hand, when the time constraint is met (step S73: YES), the divided region selection unit 124 calculates the importance of the divided region set with respect to the target correlation model (step S74). In the present embodiment, the divided region selection unit 124 calculates the sum of the importance of all the divided regions of the target divided region set as the importance of the divided region set.

Subsequently, the divided region selection unit 124 calculates (specifies) the optimum arrangement of the execution of the experiments corresponding to the divided regions in the vacant time of the production plan using the experimental expense and the experiment mutual expense of the divided region (step S75). In the present embodiment, the divided region selection unit 124 calculates, for example, an arrangement that minimizes the expense. Specifically, for all combinations when the divided regions of the divided region set are arranged in the vacant time, the expense of switching from the work of the production plan before the vacant time to an experiment performed next, the expense of switching from one experiment to the next experiment in the vacant time, and the expense of switching to the next work of the production plan after the experiment are calculated, and the arrangement that minimizes the total expense (execution cost) is determined.

Subsequently, the divided region selection unit 124 additionally stores the experimental plan information for executing the experiment of the divided region of the target divided region set according to the calculated optimum arrangement in the plan data of the storage unit 130 (step S76). In the present embodiment, the experimental plan information includes the calculated importance of the target divided region set and the expense totaled in step S75 for the target divided region set.

Subsequently, when the processing of loop 3 is executed for each divided region set and the processing of loop 3 is completed for all the divided region sets, the divided region selection unit 124 exits loop 3 and proceeds the process to step S77.

In step S77, the divided region selection unit 124 sorts the experimental plan information in the plan data in the order (descending order) of importance of the divided region set. In this way, the experimental plan information is arranged in the plan data in descending order of importance of the divided region set.

Next, the screen output process in step S17 of FIG. 9 will be described.

FIG. 16 is a flowchart of the screen output process according to an embodiment.

The screen output unit 125 extracts a predetermined number of (for example, three) pieces of experimental plan information having higher importance of the divided region set from the storage unit 130 (step S81).

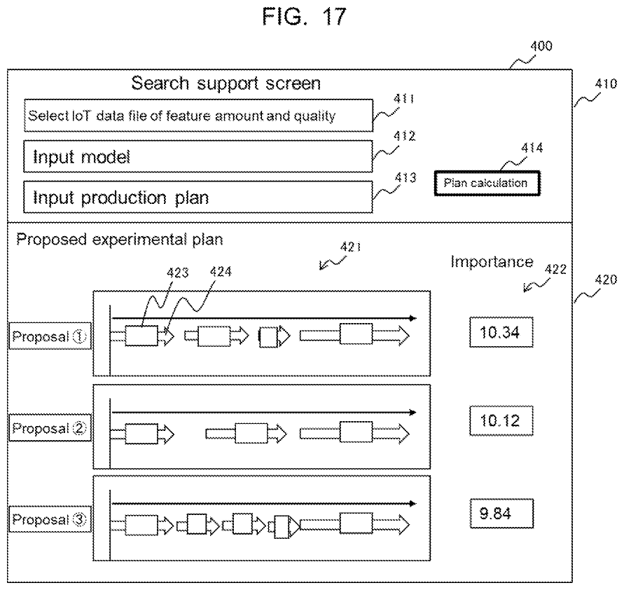

Subsequently, the screen output unit 125 creates and outputs (presents) a screen (for example, a search support screen 400 (see FIG. 17)) of a proposed experimental plan indicated by the experimental plan information on the basis of the extracted experimental plan information (step S82), and ends the process.

Next, the search support screen 400 will be described.

FIG. 17 is a diagram illustrating an example of the search support screen according to an embodiment.

The search support screen 400 is a screen displayed on the display or the like of the input/output unit 110 of the search condition presentation apparatus 100 when the search condition presentation process is executed, so as to receive the user's input from the input/output unit 110, and display the processing result of the search condition presentation process. The search support screen 400 is displayed by the screen output unit 125.

The search support screen 400 includes a target designation region 410 for designating the target of search support and a processing result display region 420 for displaying a result calculated the plan.

The target designation region 410 includes an IoT data file selection region 411, a model input region 412, a production plan input region 413, and a plan calculation button 41.

The IoT data file selection region 411 is a region for selecting an IoT data file to be used. The model input region 412 is a region for designating a file of model input data used for model creation. The production plan input region 413 is a region for designating the production plan data of the facility 200. The plan calculation button 414 is a button for starting the execution of the search condition presentation process using the file selected or input by the IoT data file selection region 411, the model input region 412, and the production plan input region 413. When the plan calculation button 414 is pressed, the search condition presentation process is executed.

The processing result display region 420 includes a proposed experimental plan display region 421 and an importance display region 422.

In the proposed experimental plan display region 421, a predetermined number of proposed experimental plans extracted in the search condition presentation process are displayed, for example, in the order of importance. In the proposed experimental plan, objects (423 and the like) indicating the actual production work (processing) and the production work (processing) in one or more experiments are arranged in time-series according to the execution order. The feature amount (execution condition: search condition) in each work is displayed on the object, and the time width required for each work is displayed by the length of an arrow (424 and the like). In the importance display region 422, the importance of the set of experimental work (that is, the divided region set) executed in each proposed experimental plan is displayed.

According to the processing result display region 420, the user can grasp the conditions of the work to be executed in each proposed experimental plan, and can easily grasp the importance of the divided region set executed in the proposed experimental plan.

The present invention is not limited to the above-described embodiment but can be changed appropriately without departing from the spirit of the present invention.

For example, in the above-described embodiment, the feature amount is stored as the model generation input data, but for example, the data used for calculating the feature amount, for example, the sensor value in the facility may be stored. In this case, the feature amount may be calculated from such data and used for processing.

In the above-described embodiment, the execution cost required for executing the proposed experimental plan may be displayed in the processing result display region 420 on the search support screen 400 in correlation with the proposed experimental plan.

In the above-described embodiment, a proposed experimental plan that falls within a predetermined execution cost may be extracted and presented. In the above-described embodiment, the experimental plan is created in consideration of the production plan, but the experimental plan in which only the experiment is continuously executed regardless of the production plan may be created.

In the above-described embodiment, a part or all of the steps of the processing performed by the CPU may be performed by a hardware circuit. In addition, the program in the above-described embodiment may be installed from a program source. The program source may be a program distribution server or a recording medium (for example, a portable recording medium).

What is claimed is:

1. A search condition presentation apparatus that presents a search condition, which is an execution condition to be searched, for a correlation model that calculates an index related to an execution result of process according to the execution condition from predetermined execution conditions, comprising:
an importance calculation unit configured to calculate a importance with respect to the search for each of a plurality of divided regions belonging to the search space, which is a space that the execution condition can take;
an execution cost calculation unit configured to calculate an execution cost required for the process under the execution condition corresponding to the divided region; and
a selection presentation unit configured to select a divided region to be actually searched from the plurality of divided regions on the basis of the importance and the execution cost and present an execution condition corresponding to the selected divided region as a search condition.

2. The search condition presentation apparatus according to claim 1, wherein
the execution cost calculation unit is configured to further calculate a switching cost between processes under the execution conditions corresponding to the respective divided regions of the plurality of divided regions, and
the selection presentation unit is configured to select a divided region set which is a set of a plurality of divided regions to be actually searched from the plurality of divided regions on the basis of the importance, the execution cost, and the switching cost.

3. The search condition presentation apparatus according to claim 1, wherein
the execution cost calculation unit is configured to calculate a processing time of each of processes under the execution conditions corresponding to the plurality of divided regions, and
the selection presentation unit is configured to select a divided region set which is a set of one or more divided regions corresponding to one or more execution conditions that can be executed in a vacant time in an operation plan of a facility that executes the process, on the basis of the processing time, and select and present a divided region set to be searched, on the basis of the importance with respect to the search of the divided region set.

4. The search condition presentation apparatus according to claim 3, wherein
the execution cost calculation unit is configured to further calculate a switching cost between processes under the execution conditions corresponding to the respective divided regions of the plurality of divided regions, and
the selection presentation unit is configured to determine an execution order of processes under the execution conditions corresponding to the divided regions in the divided region set on the basis of the processing time and the switching cost, and present the execution order of processes under the execution conditions corresponding to the divided regions.

5. The search condition presentation apparatus according to claim 3, wherein
the selection presentation unit is configured to select a plurality of divided region sets on the basis of the processing time and present the plurality of divided region sets in an order according to the importance with respect to the search for the divided region sets.

6. The search condition presentation apparatus according to claim 1, wherein
the selection presentation unit is configured to present the search condition together with the corresponding importance or execution cost.

7. The search condition presentation apparatus according to claim 1, further comprising:
a search space division unit configured to divide the search space into a plurality of divided regions.

8. The search condition presentation apparatus according to claim 7, wherein
the search space division unit is configured to receive a reference number of divisions for dividing the search space and divide the search space into a plurality of divided regions according to the number of divisions.

9. The search condition presentation apparatus according to claim 7, wherein
the model is a correlation model that calculates the index from a plurality of types of execution conditions,
the search space is a search space composed of the plurality of types of execution conditions, and
the search space division unit is configured to divide the search space into divided regions by dividing each type of execution conditions into a plurality of ranges.

10. The search condition presentation apparatus according to claim 9, wherein
the search space division unit is configured to adjust a division width for the execution condition on the basis of a degree of influence on the index for each type of execution conditions.

11. A search condition presentation method by a search condition presentation apparatus that presents a search condition, which is an execution condition to be searched, for a correlation model that calculates an index related to an execution result of processing according to the execution condition from predetermined execution conditions, the method comprising:
calculating the importance with respect to the search for each of a plurality of divided regions belonging to the search space, which is a space that the execution condition can take;
calculating an execution cost required for the process under the execution condition corresponding to the divided region; and
selecting a divided region to be actually searched from the plurality of divided regions on the basis of the importance and the execution cost, and presenting an execution condition corresponding to the selected divided region as a search condition.

12. A non-transitory computer-readable recording medium having recorded thereon a search condition presentation program for causing a computer to execute processing of presenting a search condition, which is an execution condition to be searched, for a correlation model that calculates an index related to an execution result of processing according to the execution condition from predetermined execution conditions,
the search condition presentation program causing the computer to execute:
calculating the importance with respect to the search for each of a plurality of divided regions belonging to the search space, which is a space that the execution condition can take;
calculating an execution cost required for the process under the execution condition corresponding to the divided region; and
selecting a divided region to be actually searched from the plurality of divided regions on the basis of the importance and the execution cost, and presenting an execution condition corresponding to the selected divided region as a search condition.
